(19) United States
(12) Patent Application Publication
(10) Pub. No.: US 2026/0023770 A1
(43) Pub. Date: Jan. 22, 2026

(54) SYSTEM AND METHOD FOR FEW-SHOT CROSS-DOMAIN NAMED ENTITY RECOGNITION

(71) Applicant: Walmart Apollo, LLC, Bentonville, AR (US)

(72) Inventors: Subhadip Nandi, West Bengal (IN); Neeraj Agrawal, Shahganj Agra (IN); Sudipta Modak, Bengaluru (IN); Awanish Kr Singh, Dibrugarh (IN); Priyanka Bhatt, Haryana (IN)

(21) Appl. No.: 19/265,083

(22) Filed: Jul. 10, 2025

Related U.S. Application Data
(60) Provisional application No. 63/672,484, filed on Jul. 17, 2024.

(51) Int. Cl. G06F 16/334; G06F 16/3329

(52) U.S. Cl. CPC G06F 16/3344; G06F 16/33295

(57) ABSTRACT

Systems and methods for automated named entity recognition (NER) using artificial intelligence models are disclosed. In some examples, a contextualized word embedding is generated for each of a plurality of words. Further, for each contextualized word embedding, example contextualized word embeddings are received. Each of the example contextualized word embeddings are associated with a corresponding digital textual example. A similarity value is generated between each contextualized word embedding and each of the corresponding example contextualized word embeddings. Based on the similarity values, one or more of the contextualized word embeddings are determined. An input prompt is generated that includes a command, the plurality of words, and the digital textual example associated with each of the determined contextualized word embeddings. The input prompt is then inputted to a generative artificial intelligence model to receive a response that associates at least one of the plurality of words with an entity type.

### CROSS-REFERENCE TO RELATED APPLICATIONS

This application claims priority to U.S. Provisional Patent Application No. 63/672,484, filed on Jul. 17, 2024 and entitled “Systems and Methods For Retrieval Augmented Instruction Following Model For Few-Shot Cross-Domain Named Entity Recognition,” the disclosure of which is incorporated herein in its entirety.

### TECHNICAL FIELD

This application relates generally to data identification and extraction processes and, more particularly, to automated named entity recognition data identification and extraction processes.

### BACKGROUND

Named Entity Recognition (NER) is an information extraction process designed to identify entities within natural language and categorize them into predefined entity types. NER processes can be used across a wide variety of applications, such as in interactive voice response (IVR) systems, chatbots, voice bots, digital assistants, and automated answering systems, just to name a few.

### BRIEF DESCRIPTION OF THE DRAWINGS

The features and advantages of the embodiments described herein will be more fully disclosed in, or rendered obvious by, the following detailed description of the preferred embodiments, which are to be considered together with the accompanying drawings wherein like numbers refer to like parts and, further, wherein:

FIG. 1 illustrates a block diagram of an example entity type identification system, in accordance with some embodiments;

FIG. 2 illustrates a block diagram of a Named Entity Recognition (NER) processing device for generating query responses, in accordance with some embodiments;

FIG. 3 illustrates a block diagram of a NER processing device for training an artificial intelligence model, in accordance with some embodiments;

FIG. 4A illustrates example processing workflow to train an artificial intelligence model, in accordance with some embodiments;

FIG. 4B illustrates example processing to generate query responses using a trained artificial intelligence model, in accordance with some embodiments;

FIG. 5 is a flowchart of an example method for identifying entity types in digital textual data;

FIG. 6 is a flowchart of an example method for training a generative artificial intelligence model, in accordance with some embodiments, in accordance with some embodiments;

FIG. 7 illustrates an example processing resource communicatively coupled to a computer-readable medium storing instructions, in accordance with some embodiments; and

FIG. 8 illustrates an example processing device, in accordance with some embodiments.

### DETAILED DESCRIPTION

This description of the exemplary embodiments is intended to be read in connection with the accompanying drawings, which are to be considered part of the entire written description. Terms concerning data connections, coupling, and the like, such as “connected” and “interconnected,” “communicatively coupled to,” and/or “in signal communication with” refer to a relationship wherein systems or elements are electrically and/or wirelessly connected to one another, either directly or indirectly, through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein can be assigned to the other claimed objects and vice versa. In other words, claims for the systems can be improved with features described or claimed in the context of the methods. In this case, the functional features of the method are embodied by objective units of the systems.

Named Entity Recognition (NER) is an information extraction process, designed to identify and categorize entities in natural language into predefined entity types. For example, given a list of predefined entity types Y={y1, . . . , ym} for a domain, and a sentence X={x1, . . . , xn}, an NER task may involve identifying sequences of words in X as entities and categorizing them into correct entity types. m denotes the number of entity types and n denotes a sentence length. Due to large variations in entities and the way they are used across domains, NER has been a challenging task in NLP. For example, traditional NER models may require large volumes of labelled data for training. The collection of large volumes of labelled data, however, can both costly, time-intensive, and, for many applications, not possible due to the scarcity of the data.

Few-Shot Cross-Domain NER is the process of leveraging knowledge from data-rich source domains to perform entity recognition on data-scarce target domains. Many current approaches attempt to use pre-trained language models for cross-domain NER. However, these models are often domain specific. To successfully use these models for new target domains, the model architecture is modified and/or the model parameters are finetuned. As a result, a new NER model is created for each target domain.

The embodiments described herein can address these and other technical deficiencies of NER systems. For example, the embodiments are directed to systems and methods that use artificial intelligence models, such as large language models (LLMs), to detect entity types of entities in natural language. The embodiments can generate an input prompt to an LLM that includes a command (e.g., task description), entity types and definitions, examples of input/output pairs, and the textual data (e.g., a search query) for which NER is to be performed. The input prompt is inputted to the LLM and, in response, the LLM generates output data characterizing one or more entity types of corresponding entities detected in the textual data. As described further herein, rather than having the same hardcoded domain examples appended for each request, the examples are selected dynamically, in real-time, based on a computed similarity with the textual data (e.g., the input search query). As such, in contrast to current NER systems, the embodiments described herein can use a same model (e.g., the LLM), without adjusting the model's parameters (e.g., weights), across various domains, where the embodiments may use labelled examples for a given domain to perform NER. Moreover, the embodiments can more accurately determine entity types for detected entities, decrease processing requirements, decrease model training time, and decrease model maintenance costs, among other advantages. Persons of ordinary skill in the art can recognize these and other technical benefits as well.

For instance, in some embodiments, an apparatus includes a processing resource and a non-transitory machine readable medium storing instructions. When executed by the processing resource, the instructions cause the processing resource to: receive digital textual data comprising a plurality of words; generate a contextualized word embedding for each word of the plurality of words, wherein each contextualized word embedding is generated based on a context of the word in the plurality of words; receive, for each contextualized word embedding, a plurality of example contextualized word embeddings, wherein each of the plurality of example contextualized word embeddings are associated with a corresponding digital textual example; generate, for each contextualized word embedding, a similarity value between the contextualized word embedding and each of the corresponding plurality of example contextualized word embeddings; determine, based on the similarity values, a number of contextualized word embeddings from the plurality of example contextualized word embeddings corresponding to each of the plurality of words; generate an input prompt comprising a command, the digital textual data, and the digital textual example associated with each of the number of contextualized word embeddings; input the input prompt to a generative artificial intelligence model, and receive an output response from the generative artificial intelligence model, the output response associating at least one of the plurality of words with at least one of a plurality of entity types; and transmit the output response.

In some embodiments, a method by at least one processor is disclosed. The method includes receiving digital textual data comprising a plurality of words. The method also includes generating a contextualized word embedding for each word of the plurality of words, wherein each contextualized word embedding is generated based on a context of the word in the plurality of words. Further, the method includes receiving, for each contextualized word embedding, a plurality of example contextualized word embeddings, wherein each of the plurality of example contextualized word embeddings are associated with a corresponding digital textual example. The method also includes generating, for each contextualized word embedding, a similarity value between the contextualized word embedding and each of the corresponding plurality of example contextualized word embeddings. The method further includes determining, based on the similarity values, a number of contextualized word embeddings from the plurality of example contextualized word embeddings corresponding to each of the plurality of words. The method also includes generating an input prompt comprising a command, the digital textual data, and the digital textual example associated with each of the number of contextualized word embeddings. Further, the method includes inputting the input prompt to a generative artificial intelligence model, and receiving an output response from the generative artificial intelligence model, the output response associating at least one of the plurality of words with at least one of a plurality of entity types. The method also includes transmitting the output response.

In some embodiments, a non-transitory computer-readable medium having instructions stored thereon is disclosed. The instructions, when executed by at least one processor, cause at least one device to perform operations including: receiving digital textual data comprising a plurality of words; generating a contextualized word embedding for each word of the plurality of words, wherein each contextualized word embedding is generated based on a context of the word in the plurality of words; receiving, for each contextualized word embedding, a plurality of example contextualized word embeddings, wherein each of the plurality of example contextualized word embeddings are associated with a corresponding digital textual example; generating, for each contextualized word embedding, a similarity value between the contextualized word embedding and each of the corresponding plurality of example contextualized word embeddings; determining, based on the similarity values, a number of contextualized word embeddings from the plurality of example contextualized word embeddings corresponding to each of the plurality of words; generating an input prompt comprising a command, the digital textual data, and the digital textual example associated with each of the number of contextualized word embeddings; inputting the input prompt to a generative artificial intelligence model, and receiving an output response from the generative artificial intelligence model, the output response associating at least one of the plurality of words with at least one of a plurality of entity types; and transmitting the output response.

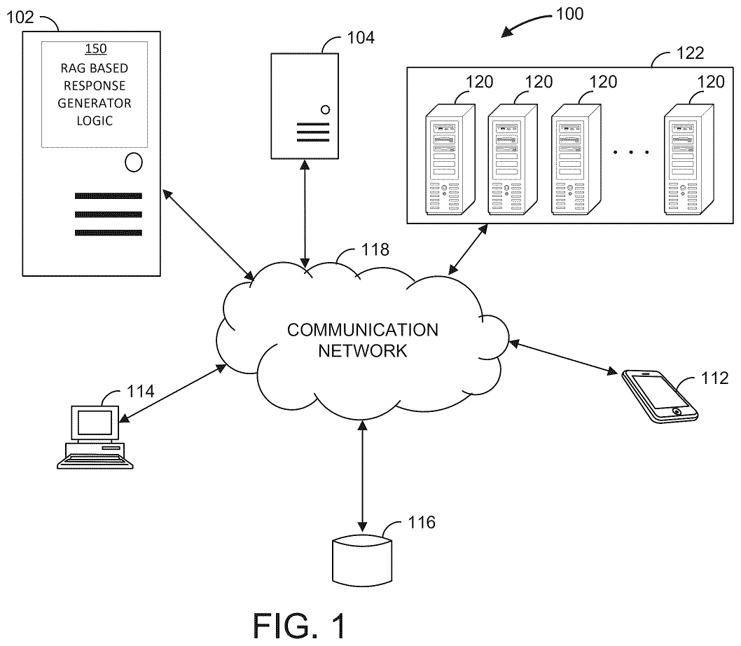

Referring now to the drawings, FIG. 1 illustrates an entity type identification system 100 that can detect entities in digital textual data (e.g., search queries), and can generate an entity type for each detected entity, in accordance with at least some embodiments described herein. As illustrated, the entity type identification system 100 includes a Named Entity Recognition (NER) processing device 102 with Retrieval Augmented Generation (RAG) based response generator logic 150, a web server 104, one or more cloud-based servers 120, one or more customer computing devices 112, 114, and a database 116 communicatively coupled over one or more communication networks 118.

The NER processing device 102, the web server 104, the cloud-based servers 120, and the multiple customer computing devices 112, 114 can each be any suitable processing device and can be implemented in any suitable hardware or hardware and software combination. For example, each of these processing devices can include one or more processors, one or more field-programmable gate arrays (FPGAs), one or more application-specific integrated circuits (ASICs), one or more digital signal processors (DSPs), one or more state machines, digital circuitry, or any other suitable circuitry. Additionally or alternatively, each processing device can include one or more computer-readable storage mediums that store executable instructions that can be executed by, for instance, one or more processors. Each of these processing devices can transmit data to, and receive data from, the communication network 118.

For instance, in some examples, the NER processing device 102 can be a computer, a laptop, a server such as a cloud-based server, or any other suitable processing device. In addition, each cloud-based server 120 can include one or more processing units, such as one or more graphical processing units (GPUs), one or more central processing units (CPUs), and/or one or more processing cores. In some examples, the cloud-based servers 120 are part of a cloud computing platform 122 that provides computing resources over the communication network 118, such as processing capabilities (e.g., virtual machines) and data storage. For example, the cloud computing platform 122 can offer computing and storage resources (e.g., cloud computing services) over the communication network 118 to the NER processing device 102 using one or more of the cloud-based servers 120.

In some examples, each of the multiple customer computing devices 112, 114 can be a cellular phone, a smart phone, a tablet, a personal assistant device, a voice assistant device, a digital assistant, a laptop, a computer, or any other suitable processing device. In some examples, the web server 104 hosts one or more online marketplaces, such as retailer websites. The multiple customer computing devices 112, 114 can execute an application, such as a browser, to access any of the online marketplaces hosted by the web server 104. In some examples, the NER processing device 102, the cloud-based servers 120, and/or the web server 104 are operated by a retailer, and the multiple customer computing devices 112, 114 are operated by customers of the retailer. In some examples, the cloud-based servers 120 are operated by a third party (e.g., a cloud-computing provider).

Although FIG. 1 illustrates two customer computing devices 112, 114, the entity type identification system 100 can include any number of customer computing devices 112, 114. Similarly, entity type identification system 100 can include any number NER processing devices 102, cloud-based servers 120, web servers 104, and databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In addition, the database 116 can be any suitable storage device. The database 116 can be a remote storage device, such as a cloud-based server, a disk (e.g., a hard disk), a memory device on another application server, a networked computer, or any other suitable remote storage. For example, database 116 can be a data repository that can store data for the entity type identification system 100. For instance, the web server 104 and the NER processing device 102 can store data to, and read data from, the database 116. Although shown remote to the NER processing device 102, in some examples, the database 116 can be a local storage device, such as a hard drive, a non-volatile memory, or a USB stick.

As described further herein, the NER processing device 102 includes RAG based response generator logic 150 that can detect entities within digital textual data, and can generate an entity type for each detected entity. The digital textual data can be, for example, a search query received from the web server 104.

For instance, web server 104 can host an online marketplace, such as a retailer's website. Each of the multiple customer computing devices 112, 114 can communicate with the web server 104 over the communication network 118. For example, each of the multiple customer computing devices 112, 114 may be operable to execute a browser to view, access, and interact with the online marketplace hosted by the web server 104. The online marketplace may include webpages that allow users to view and purchase items. Further, a webpage can include a search capability, such as a search bar or a chatbot, that allows a user to provide a search query. In some examples, a user requests a search using a voice command (e.g., via a digital assistant). In response to receiving the search query, in some examples, the web server 104 can, in real-time, transmit the search query to the NER processing device 102 to request the detection of entities and corresponding entity types within the search query.

Based on received the search query, the NER processing device 102 can generate an input prompt for an LLM. The input prompt can include a command that describes a task to the LLM, e.g.: “You are a smart and intelligent Named Entity Recognition (NER) system. You will be provided with the definition of the entities to extract, the sentence from which you need to extract the entities and the format in which you are to display the output. Be precise with the span of words that you label as entity, which means you are to only identify part of sentence that you think is an entity, not the whole sentence.”

The NER processing device 102 can also generate the input prompt to include entity type data that characterizes one or more entity types and respective definitions for a particular domain (e.g., the online marketplace). For example, entity type data can include: {product: name of a product, quantity: quantity of items corresponding to an order, carrier service: delivery or mail carrier service, etc.}. In some examples, the NER processing device 102 can generate the input prompt to also include an expected output format in which the LLM is expected to provide a response. For example, in some embodiments an output format includes a json format such as: {product: [list of string of entities present], quantity: [list of string of entities present], carrier service: [list of string of entities present] and so on}.

Further still the NER processing device 102 can generate the input prompt to include input/output example pairs. The input/output pair examples include an input field characterizing an example input to the LLM, and an output field characterizing entity types and detected entities for the input. For example, an input/output example pair can include: Input: Can I pick this up tomorrow; Output: {product: None, phone: None, quantity: None, email: None, time: tomorrow, carrier service: None, address: None, amount: None, url: None, partner: None, case or return id: None, tracking id: None}. To determine the input/output pair examples to include in the input prompt, the NER processing device 102 may generate an embedding based on the search query. In some examples, the NER processing device 102 uses an embedder to generate a contextualized word embedding for each word of the search query. Further, for each search query word, the NER processing device 102 determines a predetermined number of closest matches based on query example data stored in database 116. For instance, the query example data can include a contextualized word embedding for each word identified as an entity (e.g., every entity tagged word) in the data (e.g., sentence data, such as item descriptions) for a domain. The query example data can include, for each word, the word, the word embedding, the corresponding sentence, and a sentence label. For each word embedding of the search query, the NER processing device 102 determines a similarity score (e.g., cosine similarity score) based on each of the word embeddings in the query example data. For instance, if a search query has “N” words (e.g., “entities”) and the predetermined number of closest matches is represented by “k,” then a total of N× k examples are determined.

In some examples, to determine similarity scores, the NER processing device 102 computes a cosine similarity. For example, the NER processing device 102 can calculate the similarity s(q, d) between a query(q) embedding and an example(d) embedding according to:

s(q,d)=cos(E(q),E(d))

where E (q) and E (d) denote the query and example embeddings, respectively. The NER processing device 102 may select a predetermined number of these closest matches based on the similarity scores. For example, the NER processing device 102 may select the “k” examples with the highest similarity scores from the N x k examples.

Further still, the NER processing device 102 can generate the input prompt to include the received search query. The NER processing device 102 can then provide the input prompt to an LLM. In some examples, the LLM is executed by the NER processing device 102. The NER processing device 102 inputs the input prompt to the executed LLM, and in response received output data characterizing entity types and corresponding entities detected in the search query. The output data is formatted in accordance with the requested output format specified in the input prompt. In some examples, the output data includes the entity types as “keys” and any corresponding detected entities (e.g., sequences of one or more words) as “values.” In other examples, the NER processing device 102 transmits the input prompt to be input into an LLM executed by another device, such as a cloud-based server 120. The transmission of the input prompt causes the cloud-based server 120 to input the input prompt to the executed LLM, and to receive output data from the LLM. The cloud-based server 120 then transmits the output data to the NER processing device 102.

Regardless of how generated, the NER processing device 102 can parse the output data from the LLM to extract the detected entities and corresponding entity types. The NER processing device 102 can package the detected entities and corresponding entity types within an entity detection message, and can transmit the entity detection message to the web server 104. As described further herein, the web server 104 can receive the entity detection message, extract the entities and corresponding entity types, and use the entities and corresponding entity types to generate search results (e.g., item advertisements) in response to the search query received from the user. For instance, the web server 104 can provide item advertisements for items that are in accordance with (e.g., relevant to) the entities and corresponding entity types. Indeed, these entity predictions can allow for automated workflows for various domains, thereby reducing and/or eliminating escalations to human agents, and leading to significant yearly savings cost savings for a company, among other advantages.

In some examples, as described further herein, the NER processing device 102 finetunes an LLM using entity tagged source domain data. For instance, if the LLM is an open-source LLM that allows for finetuning, the NER processing device 102 can finetune the LLM with labelled input prompts, allowing the LLM to learn domain specific prompt instructions (e.g., commands) for an NER task. For example, the finetuning can configure the LLM to perform the NER task and generate results in the format specified in the input prompt. This finetuning process, however, is optional.

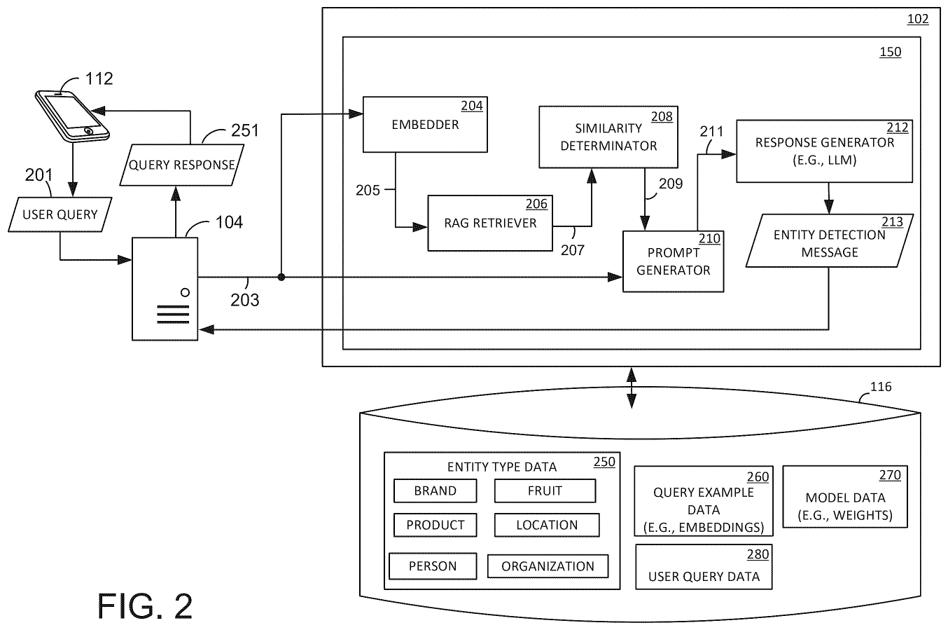

FIG. 2 illustrates further details of the entity type identification system 100 and, in particular, of the RAG based response generator logic 150 of the NER processing device 102. As illustrated, the RAG based response generator logic 150 includes an embedder 204, RAG retriever 206, similarity determinator 208, prompt generator 210, and response generator 212. Any or all parts of the RAG based response generator logic 150, including the embedder 204, RAG retriever 206, similarity determinator 208, prompt generator 210, and response generator 212, can be implemented in any suitable hardware or hardware and software combination. For example, the RAG based response generator logic 150 can include one or more processors, one or more FPGAs, one or more ASICs, one or more DSPs, one or more state machines, digital circuitry, or any other suitable circuitry to carry out the operations of each of the embedder 204, RAG retriever 206, similarity determinator 208, prompt generator 210, and response generator 212. Additionally or alternatively, the RAG based response generator logic 150 can include one or more computer-readable storage mediums that store executable instructions that can be executed by, for instance, one or more processors, to carry out the operations of each of the embedder 204, RAG retriever 206, similarity determinator 208, prompt generator 210, and response generator 212.

In this example, database 116 includes entity type data 250 characterizing entity types and their corresponding definitions. For example, entity type data 250 can include the entity types of “brand,” “fruit,” “product,” “location,” “person,” and “organization,” along with their corresponding definitions. The database 116 can also store query example data 260 characterizing input/output example pairs for a domain. As described herein, the query example data 260 can be in the form of contextualized word embeddings. For instance, to generate the query example data 260, the NER processing device 102 can apply an encoder model (e.g., bge-base-en encoder model) to item description data (e.g., sequences of words characterizing items) to generate contextualized word embeddings for each detected token. In some examples, tokens corresponding to an entity tagged word can be averaged to obtain a word-level embedding for each word (e.g., of each word sequence, sentence). The query example data 260 can include the word, the generated word embedding, the corresponding sequence of words (e.g., the sentence), and a sentence label, such as {(sound-proof, <generated embedding,>ProductFeature, ‘need sound-proof headphone,’ ‘ProductFeature ProductCategory’), (headphone, <generated embedding,>ProductCategory, ‘need sound-proof headphone,’ ‘ProductFeature ProductCategory’), . . . }.

In this example, the customer computing device 112 generates and transmits a user query 201 to the web server 104. For instance, as described herein, the user query 201 can be a search request. The web server 104 receives the user query 201, and generates an entity request message 203 that includes at least portions of the user query 201. For example, the web server 104 can extract the digital textual data characterizing the search request from the user query 201, and can populate corresponding text fields of the entity request message 203 with the extracted digital textual data. In some examples, the web server 104 generates the entity request message 203 to include a corresponding identifier (ID), such as an ID unique to the request. The web server 104 then transmits the entity request message to the NER processing device 102.

The embedder 204 receives the entity request message 203, and extracts the digital textual data and, in some examples, the ID, from the entity request message 203. The embedder 204 can store the extracted digital textual data (and, in some examples, the ID) in the database 116 as user query data 280. Further, the embedder 204 applies an encoder model (e.g., bge-base-en encoder model) to the extracted digital textual data to generate one or more query embeddings 205. Each query embedding 205 can characterize a contextualized word embedding for a corresponding word of the digital textual data, for instance. The embedder 204 transmits the query embeddings 205 to the RAG retriever 206.

The RAG retriever 206 performs operations to determine a number of most similar examples for each query embedding 205 from the query example data 260 stored in database 116. For example, as described further herein, the RAG retriever 206 can determine a similarity score, such as a cosine similarity score, based on the query embedding 205 and the embeddings characterized by the query example data 260. The RAG retriever 206 can receive from the database a predetermined number of query examples based on the similarity scores. For instance, the RAG retriever 206 can retrieve from the database 116 the four query examples with the highest similarity scores. The RAG retriever 206 can package the query examples for each query embedding 205 into a candidate example list message 207, along with their corresponding similarity scores, and can transmit the candidate example list message 207 to the similarity determinator 208.

The similarity determinator 208 can receive the candidate example list message 207 from the RAG retriever 206, and can determine a number of final query examples 209 based on the corresponding similarity scores. For example, the similarity determinator 208 may compare the similarity scores to determine the highest four similarity scores. In some examples, to determine the highest similarity scores, the similarity determinator 208 performs comparison operations, where a higher similarity score is moved up a data queue, and a lower similarity score is moved down the data queue. Once all comparisons have been made, the similarity determinator 208 selects a predetermined number (e.g., four) of the query examples associated with the highest scores. The similarity determinator 208 transmits the selected final query examples 209 to the prompt generator 210.

In addition to receiving the final query examples 209, the prompt generator also receives the 203. The prompt generator 210 extracts the digital textual data from the entity request message 203, and generates an input prompt 211 based on the extracted digital textual data and the final query examples 209. For instance, as described herein, the prompt generator 210 can generate the input prompt to include a command (e.g., task description), corresponding entity type data 250, the final query examples 209, and the extracted digital textual data. In some examples, the prompt generator 210 generates the command to include specific instructions that the entity types are to be selected from the provided input/output examples. In some examples, the prompt generator 210 generates the input prompt 211 to also include an expected output format (e.g., json format). The prompt generator 210 can generate the input prompt in accordance with a prompt format. For instance, the prompt generator 210 may generate the input prompt to include the task description, followed by the entity type data 250, followed by the requested output format, followed by the final query examples 209, followed by the extracted digital textual data. The prompt generator 210 transmits the input prompt 211 to the response generator 212.

In this example, the response generator 212 includes an LLM. The response generator 212 receives the input prompt 211, and inputs the input prompt 211 to the executed LLM. In some examples, the response generator 212 establishes the LLM based on receiving model data 270 from the database 116. For example, the model data 270 can include parameters (e.g., weights) that define the LLM. The response generator 212 may receive the model data 270 from the database 116, and may execute the LLM based on the model data 270. Based on inputting the input prompt 211 to the LLM, the LLM outputs output data characterizing entity types and corresponding entities detected in the inputted digital textual data. Based on the LLM output data, the response generator 212 generates an entity detection message 213 that includes each detected entity, and each entity's one or more corresponding entity types. In some examples, the response generator 212 generates the entity detection message 213 to also include the ID received in the entity request message 203 (e.g., and stored in database 116). The NER processing device 102 then transmits the entity detection message 213 to the web server 104.

In response to receiving the entity detection message 213, the web server 104 can generate a query response 251 (e.g., search results) based on the detected entities and corresponding entity types. The web server 104 may then transmit the query response 251 to the customer computing device 112 for display, for instance.

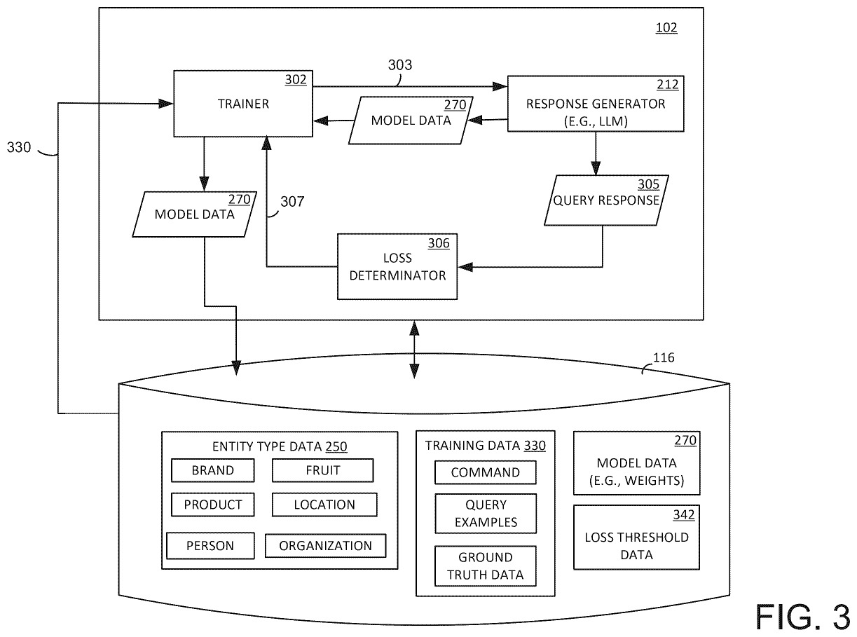

FIG. 3 illustrates further example details of the NER processing device 102 when finetuning an artificial intelligence model, such as an LLM. As illustrated, the NER processing device 102 includes a trainer 302, the response generator 212, and a loss determinator 306. As described further herein, the operations of the trainer 302, response generator 212, and loss determinator 306 can be implemented in any suitable hardware or hardware and software combination, such as by one or more processors executing corresponding instructions.

In this example, the database 116 stores training data 330, which can include a command, query examples, and ground truth data. The command can include a task description, such as “You are a smart and intelligent Named Entity Recognition (NER) system. You will be provided with the definition of the entities to extract, the sentence from which you need to extract the entities and the format in which you are to display the output. Be precise with the span of words that you label as entity, which means you are to only identify part of sentence that you think is an entity, not the whole sentence.” The query examples can include input/output pairs, such as any of the input/output pairs described herein. Finally, the ground truth data can include digital textual data and corresponding expected output data. For instance, the ground truth data can include search queries, entities for each search query, and one or more entity types corresponding to each entity.

The trainer 302 can receive the training data 330 from the database 116, and generate training input prompts 303 based on the training data 330. For example, a training input prompt 303 can include the command, a search query (e.g., based on the ground truth data), and corresponding query examples. In some examples, the ground truth data is generated such that a similarity score between each of the query examples and the corresponding search query is above a corresponding threshold (e.g., indicating a high similarity). In some examples the trainer 302 generates the training input prompts 303 in accordance with the prompt format described herein.

The response generator 212 receives the training input prompts 303, and inputs the training input prompts 303 to the execute artificial intelligence model (e.g., the LLM). In response, the artificial intelligence model outputs a query response 305. As described herein, the query response 305 can include detected entities and corresponding entity types. The response generator transmits the query response 305 to the loss determinator 306.

The loss determinator 306 receives the query response 305 from the response generator 212, and further receives the ground truth data from the training data 330 stored in the database 116. As described herein, the ground truth data includes the expected outcomes for each search query. For instance, the ground truth data can include expected entities and corresponding entity types for each search query. The loss determinator 306 can compute a loss, such as an F1-score, based on the entities and entity types of the query response 305, and the entities and entity types of the ground truth data. The loss determinator 306 can compare the computed loss to a threshold, and determine whether the artificial intelligence model is sufficiently trained based on the comparison. For example, loss threshold data 342 may include one or more threshold values, such as an F1-score threshold value. The loss determinator 306 can receive the loss threshold data 342, and can compare the computed loss value to a corresponding threshold value of the loss threshold data 342. The loss determinator 306 determines whether the artificial intelligence model is finetuned (e.g., sufficiently trained) based on the comparison.

For example, the loss determinator 306 may determine that the artificial intelligence model is finetuned when the computed loss value is below the threshold value. Further, the loss determinator 306 generates a training complete signal 307 indicating whether the artificial intelligence model is sufficiently trained. For instance, the loss determinator 306 can generate the training complete signal 307 to be a first value (e.g., logic 1) when the artificial intelligence model is sufficiently trained (e.g., loss value at or below the threshold value), and to be a second value (e.g., logic 0) when the artificial intelligence model is not sufficiently trained (e.g., loss value above the threshold value).

The trainer 302 receives the training complete signal 307 from the loss determinator 306, and determines whether training is complete based on the training complete signal 307. If the training complete signal 307 indicates that training is complete (e.g., logic 1), the trainer 302 obtains model data 270 from the response generator 212, where the model data 270 characterizes the parameters (e.g., weights) of the finetuned artificial intelligence model. The trainer 302 may store the model data 270 in the database 116. If, however, the training complete signal 307 indicates that training is not complete (e.g., logic 0), the trainer 302 may continue to train the artificial intelligence model as described herein, until the loss determinator 306 determines that the artificial intelligence model is sufficiently trained.

In some examples, once trained, the trainer 302 performs similar operations to validate the artificial intelligence model using, for example, training data 330 other than what was used during the initial training. If, during validation, the loss determinator 306 determines that a computed loss value is below a corresponding threshold value as described herein, the trainer 302 determines that the artificial intelligence model is trained and validated, and stores the model data 270 characterizing the trained and validated artificial intelligence model in the database 116.

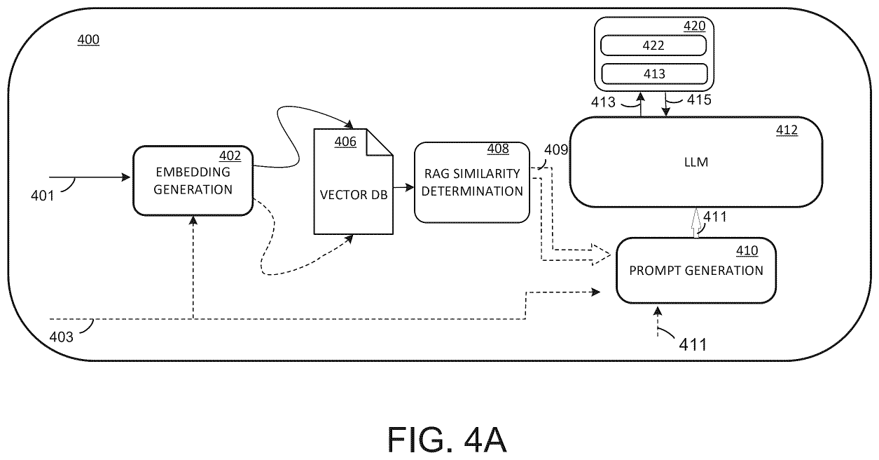

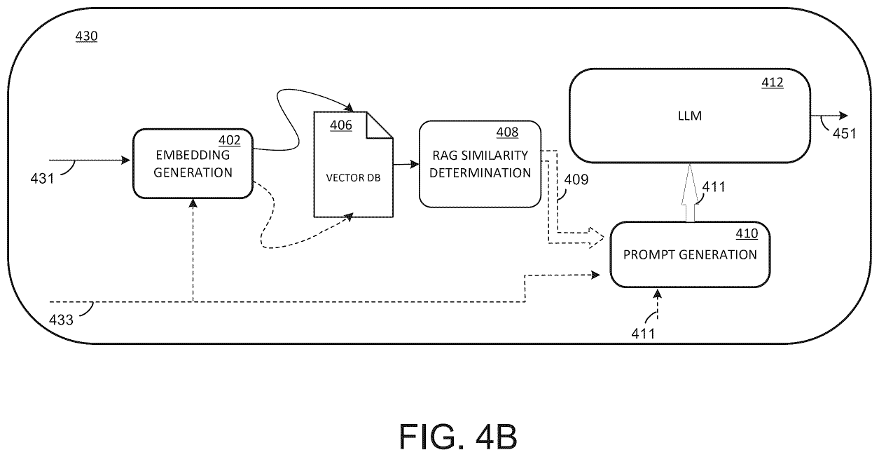

FIG. 4A illustrates a training workflow 400 that can be carried out by, for example, the NER processing device 102. In this example, at processing block 402 contextualized word embeddings are generated based on a training dataset 401 that comprises query examples and corresponding ground truth data. The contextualized word embeddings, along with the ground truth data, are stored as vectors in the vector database 406. In some examples, to augment the training dataset 401, one or more entity types are removed from a query example, and processed and stored as another query example. For example, assume a first query example includes three entity types, and the ground truth data identifies at least one entity associated with each of the three entity types. To generate a new query example, the third entity type may be removed from the query example, including from the ground truth data. The updated query example is saved as a new query example.

Contextualized word embeddings are also generated at processing block 402 for each word of a received training input sentence 403. At processing block 408, a similarity score is generated for each word of the received training input sentence 403 and each of the contextualized word embeddings stored in the vector database 406. The similarity scores characterize a similarity between the contextualized word embeddings for each word of the received training input sentence 403 and each of the contextualized word embeddings stored in the vector database 406. Based on the similarity scores, a top number of corresponding query examples 409 are determined and provided for prompt generation at processing block 410.

The generated input prompt 411 includes a command (e.g., any of the commands described herein), the corresponding query examples 409, and the received training input sentence 403. The input prompt 411 is then provided to the LLM 412. In response to receiving the input prompt 411, the LLM 412 generates an output response 413 that identifies detected entities, and their corresponding entity types, in the training input sentence 403. The LLM 412 provides the output response 413 for loss determination at processing block 420. To determine a loss value, the corresponding ground truth data 422 is compared to the output response, as described herein. A determination is then made as to whether the LLM 412 is sufficiently trained based on the loss value. For instance, the computed loss value can be compared to a threshold value. If the computed loss value is less than the threshold value, the LLM is sufficiently trained. Otherwise, if the computed loss value is at or above the threshold value, the LLM is not sufficiently trained. If the LLM 412 is not sufficiently trained, model weight updates 415 are provided to the LLM 412 to adjust the LLM's 412 parameters, and training may continue. Otherwise, if the LLM is sufficiently trained, the parameters (e.g., weights) characterizing the LLM can be stored in a database, such as model data 270 in database 116.

FIG. 4B illustrates an NER processing workflow 430 to generate query responses using a trained artificial intelligence model that can be carried out by, for example, the NER processing device 102. Here, at processing block 402 embeddings are generated based on received target domain data 431. The target domain data 431 can include description data, such as item description data (e.g., sentences describing various items). The embeddings can be contextualized word embeddings, and can be generated for each word of each string of words (e.g., each sentence). The contextualized word embeddings, along with each word, the corresponding sentence, and a sentence label, are stored as vectors in the vector database 406.

Contextualized word embeddings are also generated at processing block 402 for each word of a received input query 433. At processing block 408, similarity scores are generated based on each word of the input query 433 and each of the contextualized word embeddings stored in the vector database 406. More specifically, a similarity score is generated characterizing a similarity between the contextualized word embeddings for each word of the input query 433 and each of the contextualized word embeddings stored in the vector database 406. Based on the similarity scores, the top number of corresponding query examples 409 are determined, and provided for prompt generation at processing block 410.

At processing block 410 an input prompt 411 is generated that includes a command (e.g., any of the commands described herein), the corresponding query examples 409, and the received input query 433. The input prompt 411 is then provided to the LLM 412. In response to receiving the input prompt 411, the LLM 412 generates an output response 451 that identifies detected entities, and their corresponding entity types, in the received input query 433. The output response 451 can be used to generate item recommendations for display, for example.

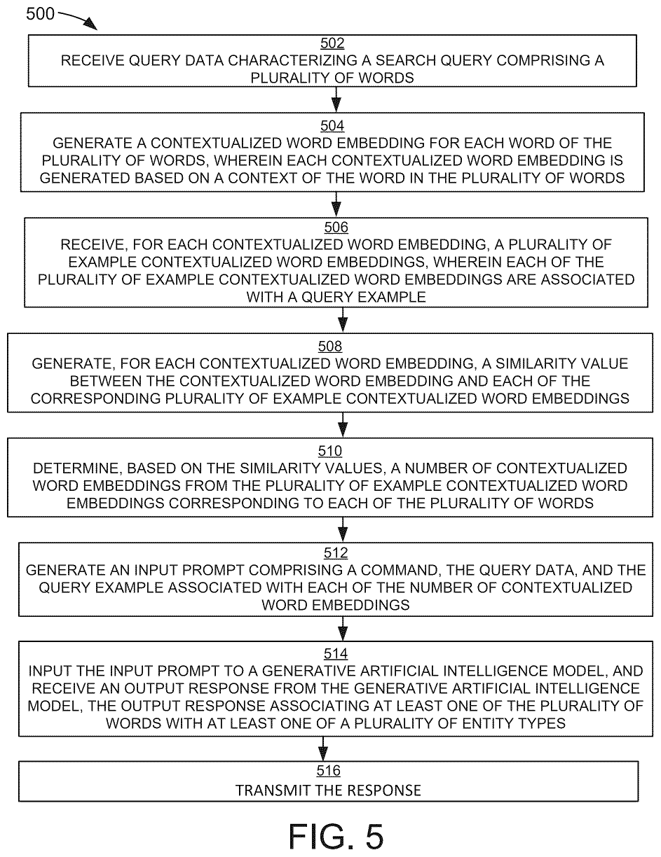

FIG. 5 illustrates a flowchart of an example method 500 for generating query responses. In some embodiments, the method 500 can be carried out by one or more computing devices, such as the NER processing device 102.

Beginning at block 502, the NER processing device 102 receives digital textual data comprising a plurality of words. For example, the NER processing device 102 can receive an entity request message 203 from the web server 104. At block 504, the NER processing device 102 generates a contextualized word embedding for each word of the plurality of words. As described herein, each contextualized word embedding is generated based on a context of the word in the plurality of words. Further, at block 506, the NER processing device 102 receives, for each contextualized word embedding, a plurality of example contextualized word embeddings, where each of the plurality of example contextualized word embeddings are associated with a corresponding digital textual example. For instance, as described herein, the NER processing device 102 can obtain query example data 260 from database 116, where the query example data 260 includes example input/output pairs.

Proceeding to block 508, the NER processing device 102 generates, for each contextualized word embedding, a similarity value between the contextualized word embedding and each of the corresponding plurality of example contextualized word embeddings. For example, the NER processing device 102 can compute a cosine similarity value between the contextualized word embedding and each of the corresponding plurality of example contextualized word embeddings. At block 510, the NER processing device 102 determines, based on the similarity values, a number of contextualized word embeddings from the plurality of example contextualized word embeddings corresponding to each of the plurality of words. For instance, the NER processing device 102 may select the contextualized word embeddings associated with the highest similarity values.

At block 512, the NER processing device 102 generates an input prompt comprising a command, the digital textual data, and the digital textual example associated with each of the number of contextualized word embeddings. As described herein, the command can include instructions to identify entities and corresponding entity types within the digital textual data. Further, at block 514, the NER processing device 102 inputs the input prompt to a generative artificial intelligence model, and receives an output response from the generative artificial intelligence model. The output response associates at least one of the plurality of words with at least one of a plurality of entity types. For instance, the NER processing device 102 can input the input prompt to an LLM (e.g., LLM 412), and based on inputting the input prompt, can receive the output response (e.g., output response 451) from the LLM. At block 516, the NER processing device 102 transmits the output response. For example, the NER processing device 102 may transmit the output response to a web server 104, causing the web server 104 to generate item recommendations based on the entities and entity types indicated by the output response, and to transmit the item recommendations for display (e.g., to a customer computing device 112, 114).

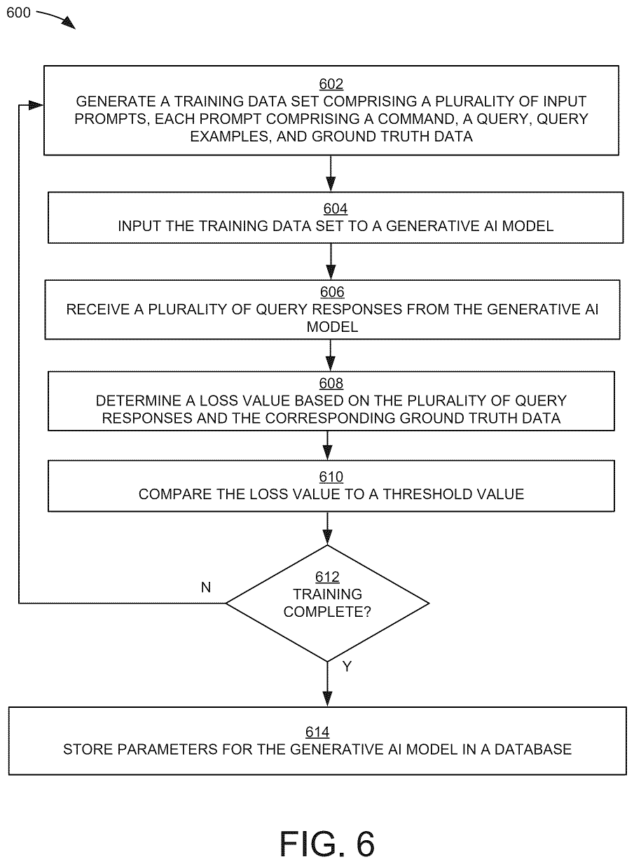

FIG. 6 illustrates a flowchart of an example method 600 for training an artificial intelligence model, such as an LLM. In some embodiments, the method 600 can be carried out by one or more computing devices, such as the NER processing device 102.

Beginning at block 602, a training dataset is generated. The training dataset includes a plurality of input prompts, where each input prompt includes a command, a search query, a number of query examples (e.g., four), and corresponding ground truth data. The ground truth data includes expected entities and entity types for each input prompt. At block 604, the input prompt is inputted to a generative artificial intelligence model, such as LLM 412. Further, at block 606, a plurality of query responses are received from the generative artificial intelligence model in response to the inputted training data set. Each query response can include one or more entities and corresponding entity types detected for each inputted query.

At block 608, a loss value is determined based on the plurality of query responses and the corresponding ground truth data. For example, an F1-score can be generated based on the entity and entity types provided by the plurality of query responses and the entity and entity types of the corresponding ground truth data. At block 610, the lost value is compared to a threshold value (e.g., a threshold value of the loss threshold data 342 stored in the database 116.

Proceeding to block 612, a determination is made as to whether training of the generative artificial intelligence model is complete based on the comparison. For example, if the computed loss value is the same or less than the threshold value, then training is complete, and the method proceeds to block 614. At block 614, the parameters associated with the generative artificial intelligence model are stored in the database (e.g., model data 270 stored in database 116). If, however, at block 612, the computed loss value is greater than the threshold value, then training is not complete, and the method proceeds back to block 602 to continue training the generative artificial intelligence model.

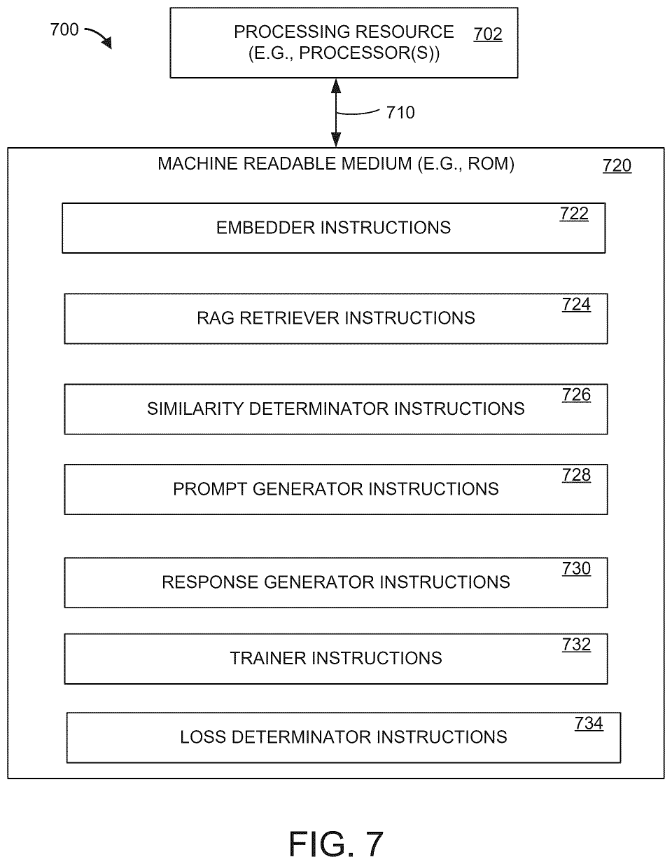

FIG. 7 illustrates an example processing device 700 that includes one or more processing resources 702 and a machine readable medium 720 that stores executable instructions. The processing resource 702 can include one or more processing devices, such as one or more processing cores, one or more CPUs, one or more GPUs, one or more FPGAs, one or more ASICs, one or more DSPs, and the like. In addition, the machine readable medium 720 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

The processing resource 702 is communicatively coupled to the machine readable medium 720 over one or more wired or wireless communication buses 710. The processing resource 702 can access instructions stored within the machine readable medium 720 via the communication bus 710, and can execute the instructions to perform corresponding operations. As illustrated, the machine readable medium 720 includes embedder instructions 722, RAG retriever instructions 724, similarity determinator instructions 726, prompt generator instructions 728, response generator instructions 730, trainer instructions 732, and loss determinator instructions 734.

The processing resource 702 can execute the embedder instructions 722 to perform one or more of the operations of the embedder 202 described herein, for example. Similarly, the processing resource 702 can execute the RAG retriever instructions 724 to perform one or more of the operations of the RAG retriever 206 described herein. In addition, the processing resource 702 can execute the similarity determinator instructions 726 to perform one or more of the operations of the similarity determinator 208 described herein. Furthermore, the processing resource 702 can execute the prompt generator instructions 728 to perform one or more of the operations of the prompt generator 210 described herein.

The processing resource 702 can also execute the response generator instructions 730 to perform one or more of the operations of the response generator 212 described herein. Additionally, the processing resource 702 can execute the trainer instructions 732 to perform one or more of the operations of the trainer 302 described herein. Further, the processing resource 702 can execute the loss determinator instructions 734 to perform one or more of the operations of the loss determinator 306 described herein.

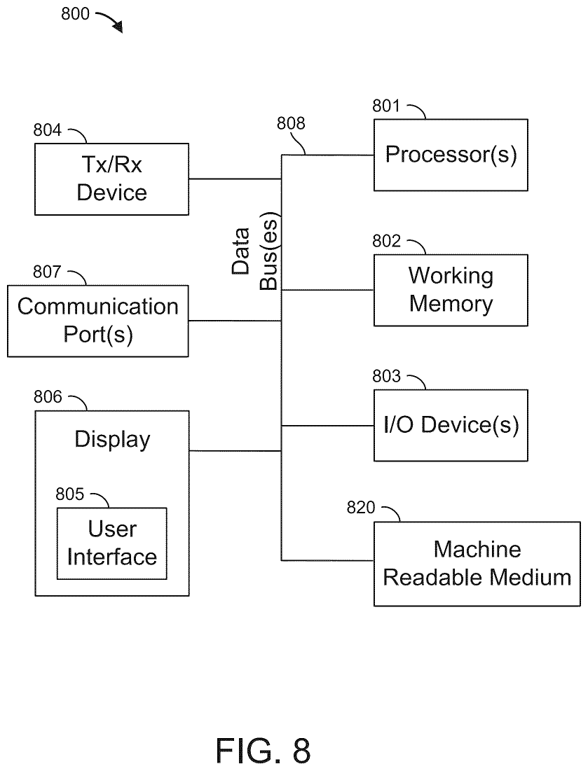

FIG. 8 illustrates a block diagram of an example computing device 800 that can carry out one or more of the operations described herein. For instance, the computing device 800 is an example of the NER processing device 102 of FIG. 1. Moreover, the web server 104, the multiple customer computing devices 112, 114, and the cloud-based servers 120 can each include one or more of the features of the computing device 800.

As shown in FIG. 8, the computing device 800 can include one or more processors 801, a working memory 802, one or more input/output devices 803, a machine readable medium 820 (e.g., instruction memory), a transceiver 804, one or more communication ports 809, and a display 806 that can display, in some examples, a user interface 805, all operatively coupled to one or more data buses 808. The data buses 808 allow for communication among the various devices and can include wired, or wireless, communication channels.

The processors 801 can include one or more distinct processors, each having one or more cores. Each of the distinct processors can have the same or different structure. The processors 801 can include one or more processing cores, one or more CPUs, one or more GPUs, one or more FPGAs, one or more ASICs, one or more DSPs, and the like.

The machine readable medium 820 can store instructions that can be accessed (e.g., read) and executed by a processing resource, such as the processors 801. The processors 801 can be configured to perform a certain function or operation by executing code, stored on the machine readable medium 720, embodying the function or operation. For example, the processors 801 can be configured to execute code stored in the machine readable medium 820 to perform one or more of any function, method, or operation disclosed herein. The machine readable medium 820 can be, for instance, the machine readable medium 720 of FIG. 7.

Additionally, the processors 801 can store data to, and read data from, the working memory 802. For example, the processors 801 can store a working set of instructions to the working memory 802, such as instructions loaded from the machine readable medium 820. The processors 801 can also use the working memory 802 to store dynamic data created during the operation of the computing device 800. The working memory 802 can be a random access memory (RAM), such as a static random access memory (SRAM) or dynamic random access memory (DRAM), or any other suitable memory.

The input/output devices 803 can include any suitable device that allows for data input or output. For example, the input/output devices 803 can include one or more of a keyboard, a touchpad, a mouse, a stylus, a touchscreen, a physical button, a speaker, a microphone, or any other suitable input or output device.

The communication port(s) 809 can include, for example, a serial port such as a universal asynchronous receiver/transmitter (UART) connection, a Universal Serial Bus (USB) connection, or any other suitable communication port or connection. In some examples, the communication port(s) 809 allows for the programming of executable instructions into the machine readable medium 820. In some examples, the communication port(s) 809 allow for the transfer (e.g., uploading or downloading) of data, such as the query example data characterizing input/output example pairs described herein.

The display 806 can be any suitable display, and may display the user interface 805. The user interfaces 805 can enable user interaction with the computing device 800. For example, the user interface 805 can be a user interface for an application (e.g., browser) that allows users to view and interact with an online marketplace. In some examples, a user can interact with the user interface 805 by engaging the input/output devices 803. In some examples, the display 806 can be a touchscreen, where the user interface 805 is displayed on the touchscreen.

The transceiver 804 allows for communication with a network, such as the communication network 118 of FIG. 1. For example, if the communication network 118 of FIG. 1 is a cellular network, the transceiver 804 is configured to allow communications with the cellular network. In some examples, the transceiver 804 is selected based on the type of the communication network 118 the computing device 800 will be operating in. The processor(s) 801 is operable to receive data from, or send data to, a network, such as the communication network 118 of FIG. 1, via the transceiver 804.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that the computer becomes a special purpose computer for practicing the methods. When implemented on a general-purpose processor, the computer program code segments configure the processor to create specific logic circuits. The methods may alternatively be at least partially embodied in application-specific integrated circuits for performing the methods.

Each functional component described herein can be implemented in computer hardware, in program code, and/or in one or more computing systems executing such program code as is known in the art. As discussed above with respect to FIG. 9, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIGS. 7 and 8, for example.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly to include other variants and embodiments which can be made by those skilled in the art.

What is claimed is:

1. An apparatus comprising:
a processing resource; and
a non-transitory machine readable medium storing instructions that, when executed, cause the processing resource to:
receive digital textual data comprising a plurality of words;
generate a contextualized word embedding for each word of the plurality of words;
receive, for each contextualized word embedding, a plurality of example contextualized word embeddings, wherein each of the plurality of example contextualized word embeddings are associated with a corresponding digital textual example;
generate, for each contextualized word embedding, a similarity value between the contextualized word embedding and each of the corresponding plurality of example contextualized word embeddings;
determine, based on the similarity values, a number of contextualized word embeddings from the plurality of example contextualized word embeddings corresponding to each of the plurality of words;
generate an input prompt comprising a command, the digital textual data, and the digital textual example associated with each of the number of contextualized word embeddings;
input the input prompt to a generative artificial intelligence model, and receive an output response from the generative artificial intelligence model, the output response associating at least one of the plurality of words with at least one of a plurality of entity types; and
transmit the output response.

2. The apparatus of claim 1 wherein the instructions, when executed, cause the processing resource to generate the command to comprise the plurality of entity types and corresponding definitions.

3. The apparatus of claim 2 wherein the instructions, when executed, cause the processing resource to generate the command to comprise instructions to extract entities corresponding to the plurality of entity types.

4. The apparatus of claim 1 wherein the instructions, when executed, cause the processing resource to generate the command to comprise a task description.

5. The apparatus of claim 1 wherein the instructions, when executed, cause the processing resource to generate the similarity values based on a cosine similarity between each contextualized word embedding and each of the corresponding plurality of example contextualized word embeddings.

6. The apparatus of claim 1 wherein the instructions, when executed, cause the processing resource to execute an encoder model that receives the digital textual data and
generates the contextualized word embedding for each word of the plurality of words.

7. The apparatus of claim 1 wherein the instructions, when executed, cause the processing resource to generate the command to comprise a request to generate the mapping data in accordance with a format (e.g., JSON file format)).

8. The apparatus of claim 1 wherein the instructions, when executed, cause the processing resource to:
generate a training data set comprising a plurality of input prompts, each input prompt comprising a training command, digital textual training data, digital textual training examples, and ground truth data;
input the training data set to the generative artificial intelligence model;
receive a plurality of responses from the generative artificial intelligence model; and
determine the generative artificial intelligence model is trained based on the plurality of responses.

9. The apparatus of claim 8 wherein the instructions, when executed, cause the processing resource to:
determine a loss value based on the plurality of responses and corresponding ground truth data;
compare the loss value to a threshold value; and
determine the generative artificial intelligence model is trained based on the comparison.

10. The apparatus of claim 8 wherein the instructions, when executed, cause the processing resource to store parameters of the trained generative artificial intelligence model in a data repository.

11. The apparatus of claim 1, wherein the generative artificial intelligence model is a large language model.

12. A method by at least one or more processors, the method comprising:
receiving digital textual data characterizing a plurality of words;
generating a contextualized word embedding for each word of the plurality of words;
receiving, for each contextualized word embedding, a plurality of example contextualized word embeddings, wherein each of the plurality of example contextualized word embeddings are associated with a digital textual example;
generating, for each contextualized word embedding, a similarity value between the contextualized word embedding and each of the corresponding plurality of example contextualized word embeddings;
determining, based on the similarity values, a number of contextualized word embeddings from the plurality of example contextualized word embeddings corresponding to each of the plurality of words;
generating an input prompt comprising a command, the digital textual data, and the digital textual example associated with each of the number of contextualized word embeddings;
inputting the input prompt to a generative artificial intelligence model, and receiving an output response from the generative artificial intelligence model; and
transmitting the output response, the output response associating at least one of the plurality of words with at least one of a plurality of entity types.

13. The method of claim 12, comprising generating the command to comprise the plurality of entity types and corresponding definitions.

14. The method of claim 13, comprising generating the command to comprise instructions to extract entities corresponding to the plurality of entity types.

15. The method of claim 12, comprising generating the command to comprise a task description.

16. The method of claim 12, comprising:
generating a training data set comprising a plurality of input prompts, each input prompt comprising a training command, digital textual training data, digital textual training examples, and ground truth data;
inputting the training data set to the generative artificial intelligence model;
receiving a plurality of responses from the generative artificial intelligence model; and
determining the generative artificial intelligence model is trained based on the plurality of responses.

17. A non-transitory computer readable medium having instructions stored thereon wherein the instructions, when executed by at least one processor, cause the at least one processor to perform operations comprising:
receiving digital textual data comprising a plurality of words;
generating a contextualized word embedding for each word of the plurality of words;
receiving, for each contextualized word embedding, a plurality of example contextualized word embeddings, wherein each of the plurality of example contextualized word embeddings are associated with a digital textual example;
generating, for each contextualized word embedding, a similarity value between the contextualized word embedding and each of the corresponding plurality of example contextualized word embeddings;
determining, based on the similarity values, a number of contextualized word embeddings from the plurality of example contextualized word embeddings corresponding to each of the plurality of words;
generating an input prompt comprising a command, the digital textual data, and the digital textual example associated with each of the number of contextualized word embeddings;
inputting the input prompt to a generative artificial intelligence model, and receiving an output response from the generative artificial intelligence model, the output response associating at least one of the plurality of words with at least one of a plurality of entity types; and
transmitting the output response.

18. The non-transitory computer readable medium of claim 17, wherein the instructions, when executed by the at least one processor, cause the at least one processor to perform operations comprising generating the command to comprise the plurality of entity types and corresponding definitions.

19. The non-transitory computer readable medium of claim 18, wherein the instructions, when executed by the at least one processor, cause the at least one processor to perform operations comprising generating the command to comprise instructions to extract entities corresponding to the plurality of entity types.

20. The non-transitory computer readable medium of claim 17, wherein the instructions, when executed by the at least one processor, cause the at least one processor to perform operations comprising:
generating a training data set comprising a plurality of input prompts, each input prompt comprising a training command, digital textual training data, digital textual training examples, and ground truth data;
inputting the training data set to the generative artificial intelligence model;
receiving a plurality of responses from the generative artificial intelligence model; and
determining the generative artificial intelligence model is trained based on the plurality of responses.
